(19) United States
(12) Patent Application Publication
(10) Pub. No.: US 2014/0093089 A1
(43) Pub. Date: Apr. 3, 2014

(54) MEMS SPEAKER DEVICE WITH AN ELECTRONIC TEST CIRCUIT

(71) Applicant: STMicroelectronics S.r.I., Agrate Brianza (IT)

(72) Inventors: Alessandro Gasparini, Cusano Milanino (IT); Daniele Depascalis, Cornaredo (IT)

(21) Appl. No.: 14/030,584

(22) Filed: Sep. 18, 2013

(30) Foreign Application Priority Data
Sep. 28, 2012 (IT) TO2012A000853

(51) Int. Cl. H04R 3/00

(52) U.S. Cl. CPC H04R 3/00
USPC 381/59

(57) ABSTRACT

A MEMS speaker device including a membrane that forms a first capacitor and a second capacitor, respectively, with a top plate and with a bottom plate. The device includes a driving circuit that operates, during a first operating period, to move the membrane into a first position, in which the membrane is close to the bottom plate, and during a second operating period, to move the membrane into a second position, in which the membrane is close to the top plate. The device includes a testing circuit having a measuring circuit, which generates a first signal, based on a capacitance of one of the first capacitor and the second capacitor and a second signal based on a capacitance of one of the first capacitor and the second capacitor; and a comparator, which compares the first and second signals with at least one first electrical reference quantity.

### BACKGROUND

1. Technical Field

The present disclosure relates to a speaker device of the MEMS (microelectromechanical systems) type, which includes an electronic test circuit. In addition, the present disclosure relates to a corresponding method for testing the speaker device.

2. Description of the Related Art

As is shown, for example, in FIG. 1, a MEMS speaker 1 comprises a plurality of membranes 2, which are arranged so as to form a planar array. For example, the MEMS speaker 1 is formed by 1024 membranes, which are arranged on thirty-two rows and thirty-two columns.

The MEMS speaker 1 further comprises, for each column, a top electrode T and a bottom electrode B, as well as a top-electrode driving circuit 4 and a bottom-electrode driving circuit 6.

The top-electrode driving circuit 4 is electrically arranged between a first supply node, which is set at a first supply voltage V_{D}, and ground. In addition, the top-electrode driving circuit 4 has an input terminal IN_{T} and an output terminal, the latter being connected to the top electrode T.

Operatively, the top-electrode driving circuit 4 is designed to impose the voltage on the top electrode T, in such a way that the latter is substantially close to the first supply voltage V_{D}, or else is substantially zero, according to the voltage present on the input terminal IN_{T}. In either case, the output terminal of the top-electrode driving circuit 4 is at low impedance, substantially zero.

The bottom-electrode driving circuit 6 is electrically arranged between the first supply node and ground. Moreover, the bottom-electrode driving circuit 6 has an input terminal IN_{B} and an output terminal, the latter being connected to the bottom electrode B.

Operatively, the bottom-electrode driving circuit 6 is designed to impose the voltage on the bottom electrode B, in such a way that the latter is substantially close to the first supply voltage V_{D}, or else is substantially zero, according to the voltage present on the input terminal IN_{B}. In either case, the output terminal of the bottom-electrode driving circuit 6 is at low impedance, substantially zero.

The MEMS speaker 1 further comprises, for each row, a membrane electrode M, which is connected to all the membranes 2 of the row. In addition, the MEMS speaker 1 comprises, for each row, a membrane-electrode driving circuit 8.

Each membrane-electrode driving circuit 8 is electrically arranged between a second supply node, which is set at a second supply voltage V_{D2}, and the first supply node. The second supply voltage V_{D2} is higher than the first supply voltage V_{D}; for example, the second supply voltage V_{D2} is twice the first supply voltage V_{D}. Moreover, the membrane-electrode driving circuit 8 has an input terminal IN_{M} and an output terminal, the latter being connected to the membrane electrode M.

Operatively, the membrane-electrode driving circuit 8 is designed to impose the voltage on the membrane electrode M in such a way that the latter is substantially close, alternatively, to the first supply voltage V_{D} or else to the second supply voltage V_{D2}, according to the voltage present on the input terminal N_{M}. In either case, the output terminal of the membrane-electrode driving circuit 8 is at low impedance, substantially zero.

From a mechanical standpoint, the MEMS speaker 1 is formed in a body of semiconductor material, which comprises a substrate 9 (FIG. 2). The top electrodes T and the bottom electrodes B are fixed with respect to the substrate 9.

As shown in FIG. 2, each top electrode T is formed by a plurality of top-electrode subregions SRT, each of which overlies, at a distance, a corresponding membrane 2. The top-electrode subregions SRT of each column are in ohmic contact with one another so as to form precisely the top electrode T. Moreover, each top-electrode subregion SRT is made, for example, of metal and is hollow so as to enable passage of air. The top-electrode subregions SRT are also known as “top plates”.

Each bottom electrode B is formed by a plurality of bottom-electrode subregions SRB, each of which is arranged underneath a corresponding membrane 2, at a distance from the latter. The bottom-electrode subregions SRB of each column are in ohmic contact with one another so as to form precisely the bottom electrode B. Moreover, each bottom-electrode subregion SRB is made, for example, of metal and is hollow so as to enable passage of air. The bottom-electrode subregions SRB are also known as “bottom plates”.

In practice, each top electrode T overlies, at a distance, the membranes 2 of the column corresponding thereto, which in turn overly, at a distance, the bottom electrode B of this column. Moreover, each bottom electrode B overlies the substrate 9.

Each membrane 2 forms, together with the corresponding top electrode T and with the corresponding bottom electrode B, and in particular together with the corresponding top plate SRT and the corresponding bottom plate SRB, an elementary unit 10, which is also known as “pixel 10”. Moreover, each membrane 2 is mobile with respect to the corresponding top plate SRT and to the corresponding bottom plate SRB, and hence is mobile with respect to the bottom electrode B and to the top electrode T of its own column. For this purpose, each membrane 2 is connected to the corresponding membrane electrode M through a first spring 11 and a second spring 13 in such a way that the membrane 2 can move vertically with respect to fixed portions of the membrane electrode M to which it is connected.

In use, the voltages of the bottom and top electrodes B, T and of the membrane electrodes M are set in such a way that the membranes 2 are subject to electrostatic forces that cause movement thereof in the vertical direction, alternatively towards the corresponding top plates SRT, or else towards the corresponding bottom plates SRB.

In particular, the movement of each membrane 2 is such that it approaches alternatively the corresponding top plate SRT or the corresponding bottom plate SRB, without, however, contacting any of them in order to prevent short circuiting.

In order to prevent short circuiting, present in each pixel 10 are one or more top spacer elements 14, also known as “top dimples”, and one or more bottom spacer elements 16, also known as “bottom dimples”. In particular, in the example shown in FIG. 2, each top plate SRT is associated to a corresponding top dimple 14, which is fixed with respect to the top plate SRT and is arranged between the top plate SRT and the corresponding membrane 2. Moreover, each bottom plate SRB is associated to a corresponding bottom dimple 16, which is fixed with respect to this bottom plate SRB and is arranged between the bottom plate SRB and the corresponding membrane 2.

In practice, each membrane 2 is mobile between i) a first position, in which it is in contact with the bottom dimple 16 of the corresponding bottom plate SRB, and is set at a distance from the top dimple 14 of the corresponding top plate SRT, and ii) a second position, in which it is in contact with the top dimple 14 of the corresponding top plate SRT, and is set at a distance from the bottom dimple 16 of the corresponding bottom plate SRB.

In use, each membrane 2 is hence made to oscillate between the aforementioned first and second positions, in such a way that each pixel 10 generates an acoustic wave, which can be perceived by a listener. In practice, each pixel 10 is able to transduce electrical signals into a respective elementary acoustic wave, the ensemble of the elementary acoustic waves generated by the pixels 10 forming the acoustic wave as a whole emitted by the MEMS speaker 1.

Considering, for example, a single pixel 10, the movement of the respective membrane 2 can be obtained by applying to this membrane 2, to the corresponding top plate SRT, and to the corresponding bottom plate SRB, and hence, respectively, to the corresponding membrane electrode M, to the corresponding top electrode T, and to the corresponding bottom electrode B, the voltages shown in FIG. 3.

For greater clarity, in FIG. 3 it is assumed that the first and second supply voltages V_{D}, V_{D2} are respectively equal to 25 V and 50 V. Moreover, it is assumed that the membrane 2 is initially latched to the bottom plate SRB, i.e., that it is in the aforementioned first position and that the voltages on the corresponding top electrode T, on the corresponding membrane electrode M, and on the corresponding bottom electrode B are such that, in the absence of variations of voltage, the membrane 2 remains in the first position. For example, it is assumed that the voltages on this top electrode T, on this membrane electrode M, and on this bottom electrode B are, respectively, equal to 0 V, 50 V and 0 V. In this way, in the absence of voltage variations, the membrane 2 remains latched to the bottom plate SRB, thanks to the considerable force of electrostatic attraction present between the membrane 2 and the bottom plate SRB, which exceeds the force of electrostatic attraction present between this membrane 2 and the corresponding top plate SRT. This is due to the fact that, even though the voltage present between the membrane 2 and the corresponding bottom plate SRB is equal to the voltage present between the membrane 2 and the corresponding top plate SRT, the membrane 2 is closer to the corresponding bottom plate SRB than to the corresponding top plate SRT.

This being said, while the voltage on the top electrode T is kept at zero, the voltage on the membrane electrode M is reduced to 25 V, and simultaneously the voltage on the bottom electrode B is raised to 25 V. In this way, the voltage present between the membrane 2 and the corresponding bottom plate SRB vanishes, and consequently the force of electrostatic attraction present between them vanishes. The membrane 2 hence tends to move vertically in the direction of the corresponding top plate SRT, on account of the voltage difference present between the membrane 2 and the corresponding top plate SRT. Next, after the membrane 2 has moved away from the corresponding bottom plate SRB by a distance greater than a distance known as “critical distance”, the voltage on the membrane electrode M is raised to 50 V, whereas the voltage on the bottom electrode B is reduced to 0 V; instead, the voltage on the top electrode T is kept at zero. In this way, the membrane 2 is latched to the top plate SRB. It should be noted how by “latching of a membrane to a plate”, whether top or bottom, is generally meant the fact that this plate is effectively the plate that corresponds to the membrane, i.e., overlies the membrane, or else is overlaid by the membrane, with respect to which it is to a first approximation aligned.

Next, in order to latch again the membrane 2 to the bottom plate SRB, the voltage on the membrane electrode M is reduced to 25 V, and simultaneously the voltage on the top electrode T is raised to 25 V. By so doing, the membrane 2 tends to move vertically in the direction of the corresponding bottom plate SRB, on account of the voltage difference present between the membrane 2 and the corresponding bottom plate SRB. Next, after the membrane 2 is at a distance from the bottom electrode B lower than the critical distance, the voltage on the membrane electrode M is raised to 50 V, whereas the voltage on the top electrode T is reduced to 0 V; instead, the voltage on the bottom electrode B is kept at zero.

In this way, the membrane 2 is latched to the bottom plate SRB.

In greater detail, the membranes 2 are actuated by a control unit 15, which is connected at output to the input terminals IN_{T} of the top-electrode driving circuits 4, to the input terminals IN_{B} of the bottom-electrode driving circuits 6, and to the input terminals IN_{M} of the membrane-electrode driving circuits 8.

The control unit 15 receives at input a clock signal CLK and a frame signal LATCH, which has a frequency equal to one thirty-second of the frequency of the clock signal CLK. In this way, the control unit 15 defines a succession of frames, each of which is formed by thirty-two bits.

The control unit 15 moreover receives a first control signal ROW, a second control signal CTOP and a third control signal CBOT, each of which defines, for each frame, thirty-two bits. These first, second, and third control signals ROW, CTOP, and CBOT hence enable indexing, at each frame, of all the pixels 10 of the MEMS speaker 1. In fact, each bit of the first control signal ROW is associated to a corresponding membrane electrode M, while each bit of the second control signal CTOP is associated to a corresponding top electrode T, and each bit of the third control signal CBOT is associated to a corresponding bottom electrode B.

The clock signal CLK, the frame signal LATCH, and the first, second, and third control signals ROW, CTOP and CBOT can be generated, for example, by an external electronic unit (not shown).

As shown in FIG. 4, the control unit 15 processes the clock signal CLK, the frame signal LATCH, and the first, second, and third control signals ROW, CTOP and CBOT so as to generate corresponding voltages on the input terminals IN_{T} of the top-electrode driving circuits 4, on the input terminals IN_{B} of the bottom-electrode driving circuits 6, and on the input terminals IN_{M} of the membrane-electrode driving circuits 8.

For example, FIG. 4 shows three successive frames, with particular reference to an example pixel, which is associated to the second bit (BIT1) of the first control signal ROW and to the third bit (BIT2) of the second and third control signals CTOP, CBOT, i.e., with particular reference to the pixel the membrane of which i) is connected to the membrane electrode M associated to the second bit of the first control signal ROW, ii) is overlaid by the top plate SRT connected to the top electrode T associated to the third bit of the second control signal CTOP, and iii) overlies the bottom plate SRB connected to the bottom electrode B associated to the third bit of the third control signal CBOT. Moreover, FIG. 4 shows the plots of the voltages V_{ROW1}, V_{CTOP2} and V_{CBOT2}, which are respectively the voltages of the membrane electrode M and of the top electrode T and bottom electrode B corresponding to the example pixel. In addition, in FIG. 4 it is assumed that, during the first frame, the membrane of the example pixel is latched to the bottom plate.

This being said, as regards the first frame, the second bit of the first control signal ROW and the third bit of the second control signal CTOP are at low logic values, while the third bit of the second control signal CTOP is at a high logic value. This implies that, during the second frame, the voltage V_{ROW1} is reduced to V_{D}, and the voltage V_{CTOP2} is kept at zero, while the voltage V_{CBOT2} is raised to V_{D}.

During the second frame, the second bit of the first control signal ROW is at a high logic value, while the third bits of the second and third control signals CTOP, CBOT are at low logic values. Consequently, during the third frame, the voltage V_{ROW1} is raised again to V_{D2}, and the voltage V_{CTOP2} is kept at zero, while the voltage V_{CBOT2} is set at zero. In this way, in the time that elapses between the three frames shown in FIG. 4, the membrane of the example pixel is brought, starting from the condition of latching to the bottom plate, to the condition of latching to the top plate.

Irrespective of the details regarding the modalities of control of the MEMS speaker 1, there is room to improve the manufacture, or in any case integrity, of the MEMS speaker 1. In particular, testing, given any pixel 10, the capacity of the corresponding membrane to latch to the corresponding top plate and/or to the corresponding bottom plate may be beneficial.

### BRIEF SUMMARY

One embodiment of the present disclose provides a testing method to verify the integrity of at least one pixel of the MEMS speaker.

One embodiment of the present disclosure is directed to a MEMS speaker device that includes an elementary unit, said elementary unit including: a membrane, a top plate, and a bottom plate, the membrane being between the top plate and the bottom plate and configured to form a first capacitor and a second capacitor, with the top plate and with the bottom plate, respectively. The device includes an electronic driving circuit configured to operate, during a first operating period, to move the membrane into a first position, in which the membrane is closer to the bottom plate, and during a second operating period, to move the membrane into a second position, in which the membrane is closer to the top plate. The device also includes an electronic test circuit that includes: a first measuring circuit configured to generate a first measurement signal based on a capacitance of one of the first and second capacitors, after the first operating period, said first measuring circuit being configured to generate a second measurement signal based on the capacitance of one of the first and second capacitors, after the second operating period, and a first comparator circuit configured to compare said first and second measurement signals with at least one first electrical reference quantity, to detect a mobility of the membrane in a direction of the top plate or the bottom plate, based on the comparison.

### BRIEF DESCRIPTION OF THE SEVERAL VIEWS OF THE DRAWINGS

According to the present disclosure a MEMS speaker device and a testing method are hence provided.

For a better understanding of the present disclosure preferred embodiments are now described, purely by way of non-limiting examples, with reference to the attached drawings, in which:

FIG. 1 shows an equivalent electrical circuit of a portion of a MEMS speaker of a known type;

FIG. 2 shows schematically cross sections of two pixels of the MEMS speaker shown in FIG. 1;

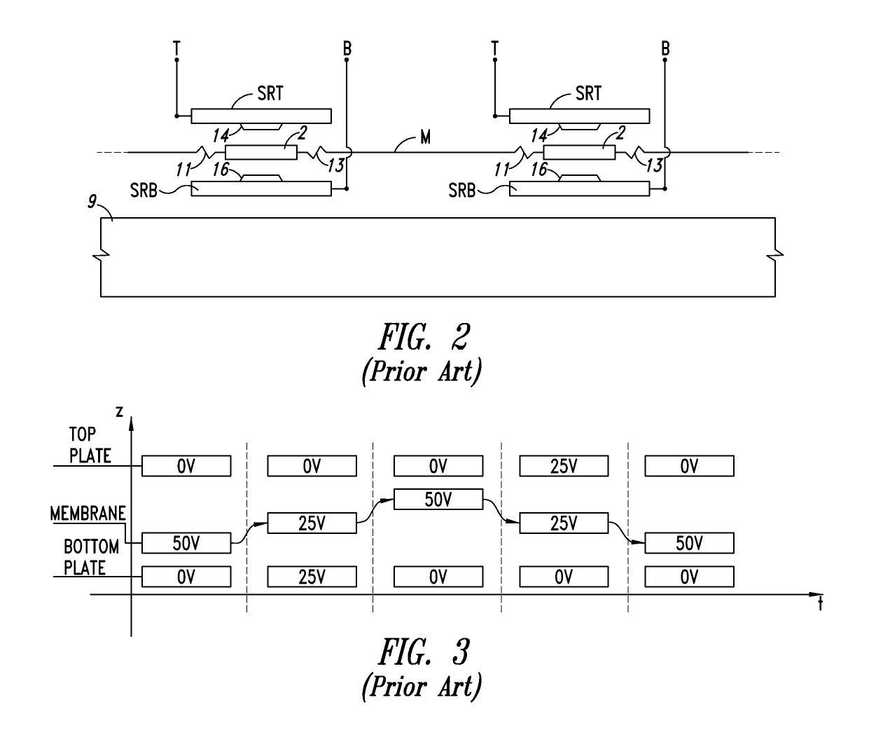

FIG. 3 shows a diagram that gives, on a first axis, a time co-ordinate (t) and, on a second axis, a space co-ordinate (z), this diagram showing the evolution in time of the position of the membrane of a pixel, as well as the evolution in time of the voltages of the top plate, of the bottom plate, and of the membrane of this pixel;

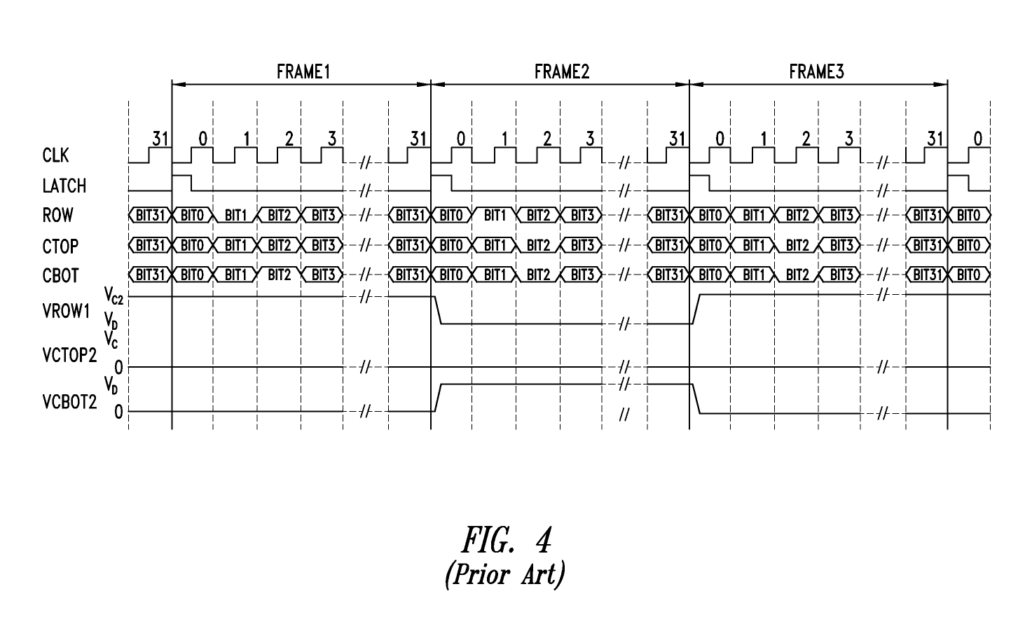

FIG. 4 shows the evolution in time of electrical signals generated within a MEMS speaker;

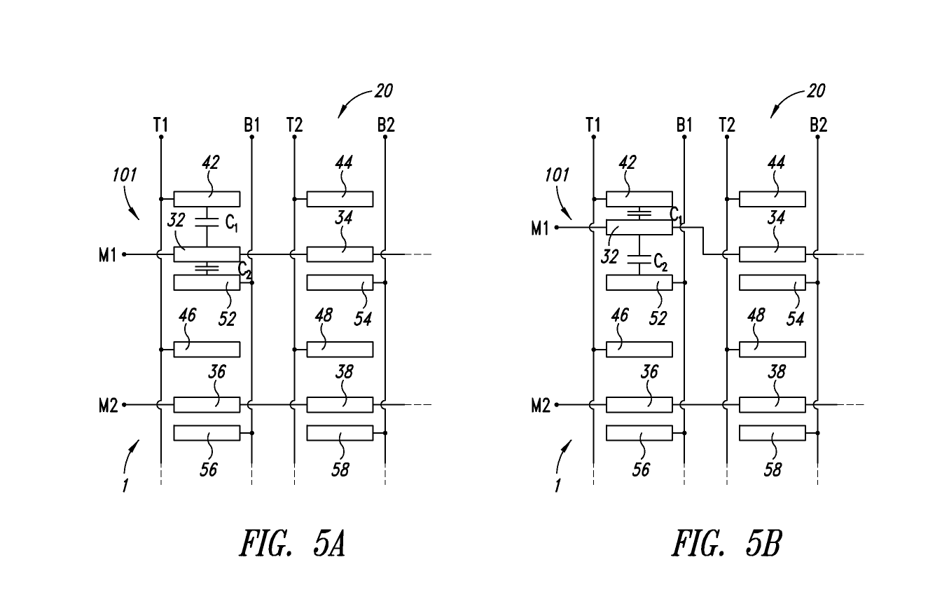

FIGS. 5a and 5b show schematically portions of a speaker device according to the present disclosure;

FIG. 6 shows an equivalent electrical circuit of a portion of the speaker device shown in FIGS. 5a and 5b, during a first operating step;

FIG. 7 shows the equivalent electrical circuit illustrated in FIG. 6, during a second operating step;

FIGS. 8 and 10 show time plots of electrical signals generated within the present speaker device; and

FIG. 9 shows an equivalent electrical circuit of a different embodiment of the present speaker device.

### DETAILED DESCRIPTION

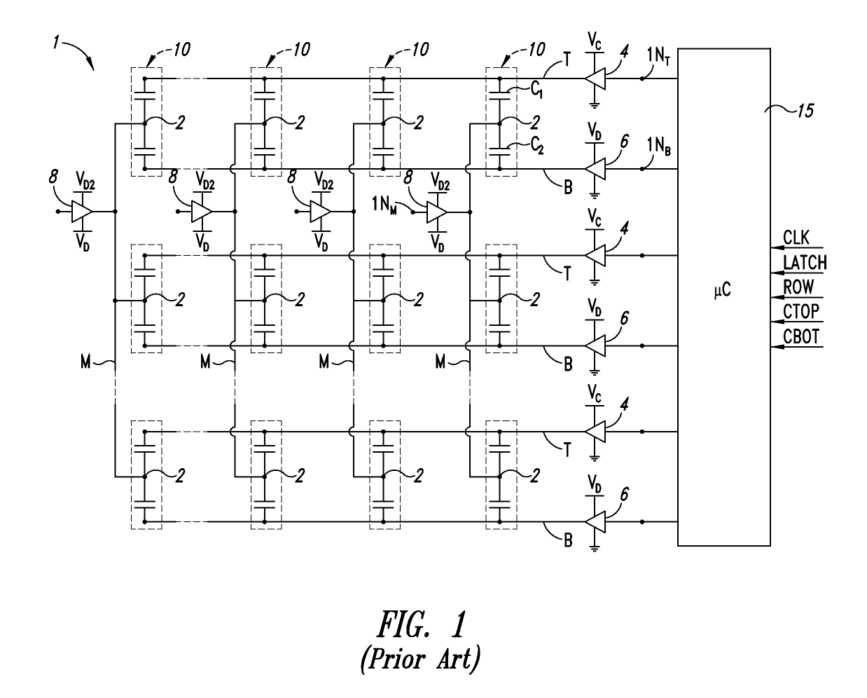

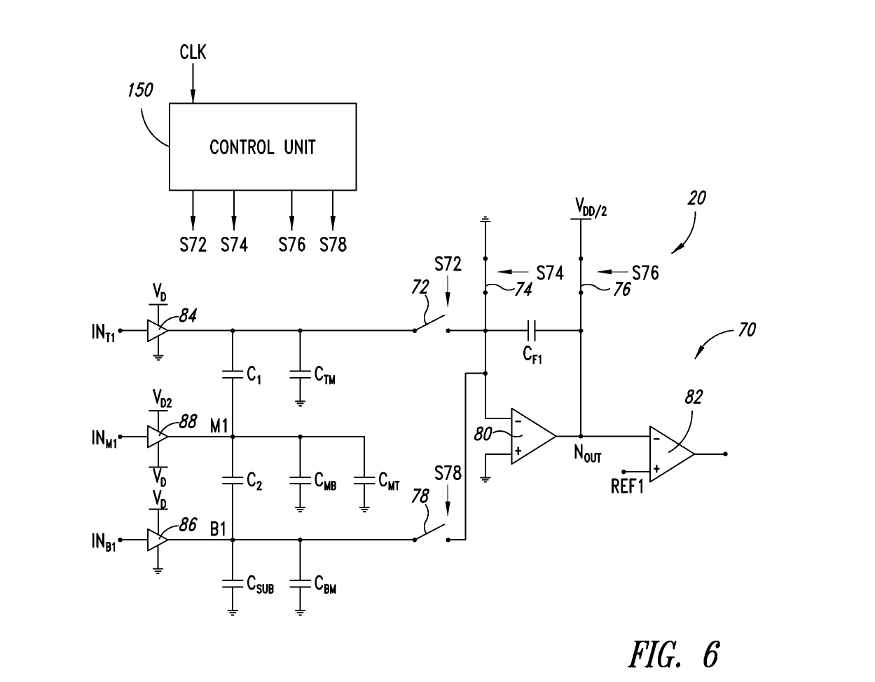

FIGS. 5a and 5b show a speaker device 20, which comprises the MEMS speaker 1 shown in FIG. 1. Components of the speaker device 20 already shown in FIG. 1 are designated by the same references, except where otherwise specified.

Moreover, the present description focuses primarily on the differences between the speaker device 20 and the MEMS speaker 1.

Purely by way of example, each of FIGS. 5a and 5b shows a first membrane 32, a second membrane 34, a third membrane 36, and a fourth membrane 38. The first and second membranes 32, 34 belong to a first row of the MEMS speaker 1, and are hence connected together, as well as to a first membrane electrode M1; the third and fourth membranes 36, 38 belong, instead, to a second row, and are hence connected together, as well as to a second membrane electrode M2.

More in particular, the first membrane 32 is arranged between a first top plate 42 and a first bottom plate 52, at a distance therefrom, these plates forming, respectively, a first top electrode T1 and a first bottom electrode B1.

The second membrane 34 is arranged between a second top plate 44 and a second bottom plate 54, at a distance therefrom, these plates forming, respectively, a second top electrode T2 and a second bottom electrode B2.

The third membrane 36 is arranged between a third top plate 46 and a third bottom plate 56, at a distance therefrom, these plates forming, respectively, the first top electrode T1 and the first bottom electrode B1.

The fourth membrane 38 is arranged between a fourth top plate 48 and a fourth bottom plate 58, at a distance therefrom, these plates forming, respectively, the second top electrode T2 and the second bottom electrode B2.

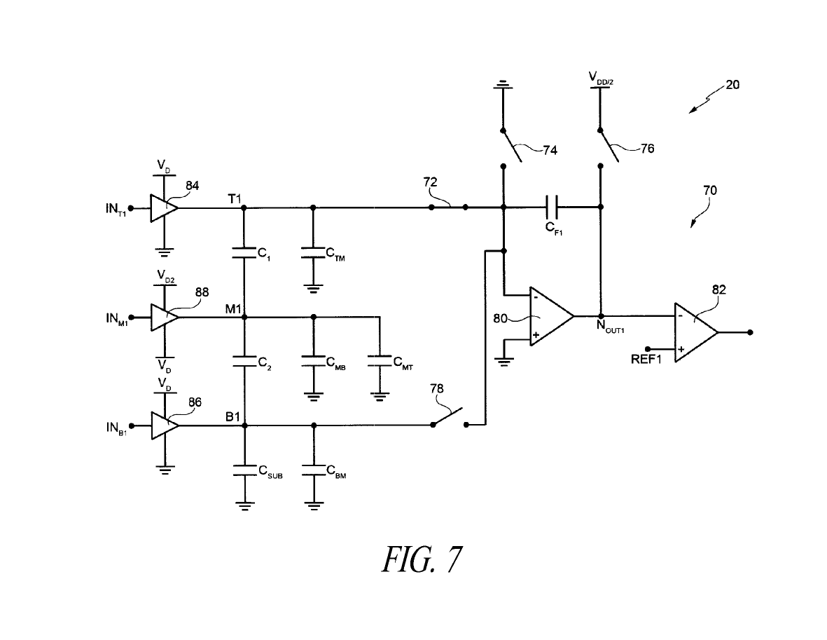

This being said, according to a first embodiment, shown in FIG. 6, the speaker device 20 comprises a testing circuit 70, which include a first switch 72, a second switch 74, a third switch 76, and a fourth switch 78, as well as a detection capacitor C_{F1} and a first differential amplifier 80 and a second differential amplifier 82. Moreover shown in FIG. 6 are the first membrane electrode M1, the first top electrode T1, and the first bottom electrode B1. FIG. 6 moreover shows a first top-electrode driving circuit 84, a first bottom-electrode driving circuit 86, and a first membrane-electrode driving circuit 88, these output terminals being, respectively, connected to the first top electrode T1, to the first bottom electrode B1, and to the first membrane electrode M1. The input terminals of the first top-electrode driving circuit 84, of the first bottom-electrode driving circuit 86, and of the first membrane-electrode driving circuit 88 are, respectively, designated by IN_{T1}, IN_{B1} and IN_{M1}.

The testing circuit 70 is common to all the pixels 10 of the speaker device 20. In particular, the second and third switches 74, 78, the detection capacitor C_{F1} and the first and second differential amplifiers 80, 82 are shared between all the pixels 10 of the MEMS speaker 1. To each pixel 10 there corresponds, instead, a pair of respective switches, which will be referred to also as “pixel switches”; given a pixel, one between the two pixel switches is arranged between the top electrode T corresponding to this pixel and the negative input terminal of the first differential amplifier 80, whereas the other is arranged between the bottom electrode B corresponding to this pixel and the negative input terminal of the first differential amplifier 80.

As shown once again in FIG. 6, present between the first top electrode T1 and the first membrane electrode M1 is a first capacitor C₁, whilst present between the first membrane electrode M1 and the first bottom electrode B1 is a second capacitor C₂. In practice, the plates of the first capacitor C₁ are formed, respectively, by the first top plate 42 and by the first membrane 32, whereas the plates of the second capacitor C₂ are formed, respectively, by the first membrane 32 and by the first bottom plate 52.

Between the first top electrode T1 and ground a third capacitor C_{TM} is moreover present, the capacitance of which is equal to the summation of the capacitances of the capacitors formed by the first top electrode T1 and, respectively, by the membranes other than the first membrane 32 and belonging to the same column to which the first membrane 32 belongs.

Moreover present between the first membrane electrode M1 and ground are a fourth capacitor C_{MB} and a fifth capacitor C_{MT}. In particular, the capacitance of the fourth capacitor C_{MB} is equal to the summation of the capacitances of the capacitors formed by the first membrane electrode M1 and, respectively, by the bottom plates SRB belonging to the columns other than the column to which the first membrane 32 belongs. The capacitance of the fifth capacitor C_{MT} is equal to the summation of the capacitances of the capacitors formed by the first membrane electrode M1 and, respectively, by the top plates SRT belonging to the columns other than the column to which the first membrane 32 belongs.

Moreover present between the first bottom electrode B1 and ground are a sixth capacitor C_{SUB} and a seventh capacitor C_{BM}. In particular, the capacitance of the sixth capacitor C_{SUB} is equal to the capacitance of the capacitor formed by the first bottom electrode B1 and by the substrate 9; the capacitance of the seventh capacitor C_{BM} is, instead, equal to the summation of the capacitances of the capacitors formed by the first bottom electrode B1 and, respectively, by the membranes other than the first membrane 32 and belonging to the same column to which the first membrane 32 belongs.

Once again with reference to the testing circuit 70, as mentioned previously, the first switch 72 is connected between the first top electrode T1 and the negative input terminal of the first differential amplifier 80.

The second switch 74 is connected between ground and the negative input terminal of the first differential amplifier 80.

The third switch 76 is connected between the output terminal of the first differential amplifier 80 and a third supply node, which is set, in use, at a third supply voltage V_{DD}/2, which is, for example, of a few volts.

The fourth switch 78 is connected between the first bottom electrode B1 and the negative input terminal of the first differential amplifier 80.

The first, second, third, and fourth switches 72, 74, 76, 78 are controlled by a control unit 150, as described hereinafter. The control unit receives at least a clock signal CLK and provides control signals S72, S74, S76, S78 for the first, second, third, and fourth switches 72, 74, 76, 78. Moreover, the detection capacitor C_{F1} is connected between the negative input terminal and the output terminal of the first differential amplifier 80 so as to feedback the latter. The positive input terminal of the first differential amplifier 80 is connected to ground.

The negative input terminal of the second differential amplifier 82 is connected to the output terminal of the first differential amplifier 80, the latter output terminal defining a first output node N_{OUT1}, whereas the positive input terminal of the second differential amplifier 82 is set, in use, at a first reference voltage REF1. In practice, the second differential amplifier 82 functions as comparator.

The first membrane 32 belongs to a first pixel 101. To verify the integrity of this first pixel 101, and hence correct mobility of the first membrane 32, it is possible to carry out the operations described hereinafter.

Initially, at an instant t₀, the first and fourth switches 72, 78 are open, whereas the second and third switches 74, 76 are closed, as shown in FIG. 6. In this way, the detection capacitor C_{F1} is charged to a voltage equal to the third supply voltage V_{DD}/2; consequently, the first differential amplifier 80 is biased in a corresponding working point.

Next, all the membranes are latched, in a way in itself known, to the corresponding bottom plates SRB. In other words, each membrane is closer to the corresponding bottom plate SRB than to the corresponding top plate SRT. With reference to the first membrane 32, it is set in the proximity of the first bottom plate 52, as shown for example in FIG. 5a. Purely by way of example, latching of the membranes is carried out between an instant t_{BOT1} and an instant t_{BOT2}.

In this way, the speaker device 20 is controlled in a known state, irrespective of any state assumed by this speaker device 20 previously.

Next, at an instant t_{HZ1}, the first top-electrode driving circuit 84 is controlled, in a way in itself known, so as to operate in the so-called high-impedance mode. In other words, the output terminal of the first top-electrode driving circuit 84 is set at an ideally infinite impedance; hence, it is electrically uncoupled from the first top electrode T1.

Next, at an instant t_{SW1}, the first switch 72 is closed by the control unit 150.

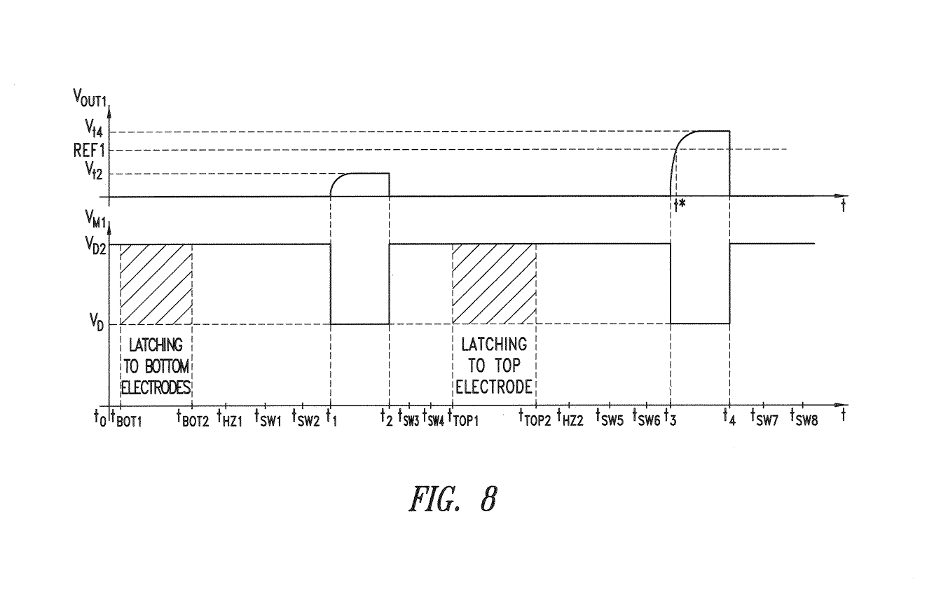

Then, at an instant t_{SW2}, the second and third switches 74, 76 are opened by the control unit 150, as shown in FIG. 7.

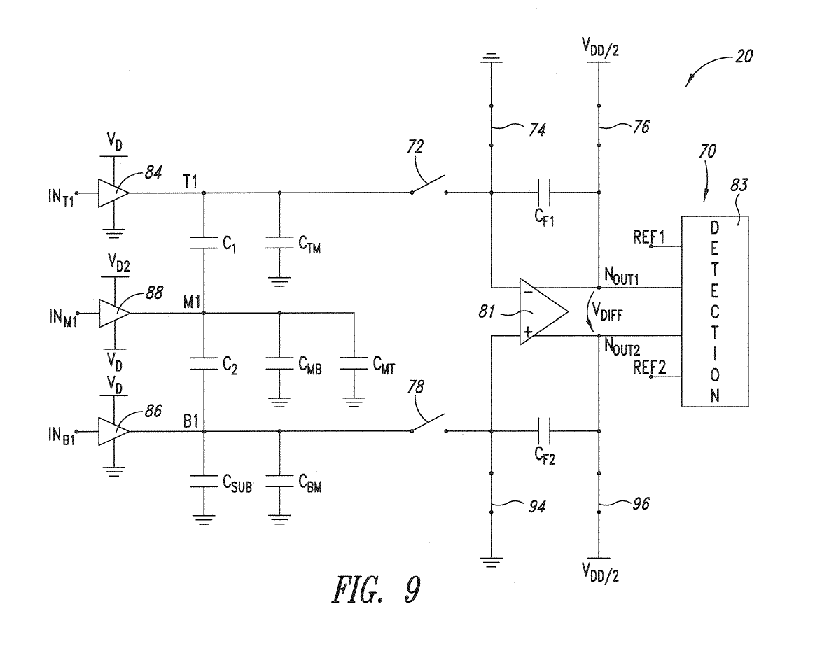

The control unit 150 then applies a first stimulation signal to the input terminal IN_{M1} of the first membrane-electrode driving circuit 88. The first stimulation signal is shown in FIG. 8, where the voltage on the input terminal IN_{M1} is designated by V_{M1}.

The first stimulation signal is formed by a first falling edge, which takes place at an instant t1 and is followed by a first rising edge, which takes place at an instant t₂. The first falling edge extends between the second supply voltage V_{D2} and the first supply voltage V_{D}, whereas the first rising edge extends between the first supply voltage V_{D} and the second supply voltage V_{D2}. In addition, before the first falling edge, the input terminal IN_{M1} of the first membrane-electrode driving circuit 88 is set at the second supply voltage V_{D2}, because the first membrane 32 has been previously latched to the first bottom plate 52. In this condition, the capacitance of the first capacitor C₁ is lower than the capacitance of the second capacitor C₂.

Since the first switch 72 is closed, and the second and third switches 74, 76 are open, in the time interval comprised between the instants t₁ and t2 the first differential amplifier 80 functions as inverting amplifier. More in particular, present on the first output node N_{OUT1} is a first output voltage V_{OUT1}, which at the instant t₁ is equal to the third supply voltage V_{DD}/2, and then increases until it assumes, at the instant t₂, a value Vₜ₂. In particular, the first output voltage V_{OUT1} increases according to an exponential law, and moreover we have Vₜ₂=(V_{D2}−V_{D})*C₁/C_{F1}, where the capacitance of the first capacitor C₁ and of the detection capacitor C_{F1} are designated by the references used for designating the corresponding capacitors (i.e., C₁ and C_{F1}).

Next, at an instant t_{SW3}, the second and third switches 74, 76 are closed so as to charge again the detection capacitor C_{F1} to a voltage equal to the third supply voltage V_{DD}/2, maintaining the feedback of the first differential amplifier 80.

Next, at an instant t_{SW4}, the first switch 72 is opened.

Then, as shown in FIG. 5b, the first membrane 32 is latched to the first top plate 42, whereas the other membranes maintain the respective positions and hence remain latched to the corresponding bottom plates SRB.

Purely by way of example, the operations having the purpose of latching the first membrane 32 to the first top plate 42 occur in a time interval comprised between an instant t_{TOP1} and a subsequent instant t_{TOP2}.

Next, at an instant t_{HZ2}, the first top-electrode driving circuit 84 is controlled, in a way in itself known, so as to operate in so-called high-impedance mode.

Next, at an instant t_{SW5}, the first switch 72 is closed.

Then, at an instant t_{SW6}, the second and third switches 74, 76 are opened.

The control unit 150 then applies a second stimulation signal to the input terminal IN_{M1} of the first membrane-electrode driving circuit 88. In practice, the first and second stimulation signals form corresponding pulses. In addition, the first and second stimulation signals form a membrane driving signal, the latter being defined by the voltage V_{M1} present on the input terminal IN_{M1} of the first membrane-electrode driving circuit 88.

In detail, as shown once again in FIG. 8, the second stimulation signal is formed by a second falling edge, which occurs at an instant t₃ and is followed by a second rising edge, which occurs at an instant t₄. The second falling edge extends between the second supply voltage V_{D2} and the first supply voltage V_{D}, whilst the second rising edge extends between the first supply voltage V_{D} and the second supply voltage V_{D2}. Moreover, before the second falling edge, the input terminal IN_{M1} of the first membrane-electrode driving circuit 88 is at the second supply voltage V_{D2}, because the first membrane 32 has been previously latched to the first top plate 42. In this condition, the capacitance of the first capacitor C₁ is higher than the capacitance of the second capacitor C₂.

Since the first switch 72 is closed, and the second and third switches 74, 76 (as well as the fourth switch 78) are open, in the time interval comprised between the instants t₃ and t₄ the first differential amplifier 80 functions as inverting amplifier. More in particular, at the instant t₃ the first output voltage V_{OUT1} is equal to the third supply voltage V_{DD}/2, and then increases until it assumes, at the instant t₄, a value Vₜ₄. In particular, the first output voltage V_{OUT1} increases with an exponential law, and moreover we have Vₜ₄=(V_{D2}−V_{D})*C₁/C_{F1}. Since, in the time interval comprised between the instants t₃ and t₄, the capacitance of the first capacitor C₁ is higher than the capacitance that this first capacitor C₁ has during the time interval comprised between the instants t₁ and t₂, the relation Vₜ₄>Vₜ₂ applies.

Next, at an instant t_{SW7}, the second and third switches 74, 76 are closed. Finally, at an instant t_{SW8}, the first switch 72 is opened.

In greater detail, the first reference voltage REF1 is set in a way in itself known, on the basis of the expected deflection of the first membrane 32, and hence of the corresponding expected values of the capacitance of the first capacitor C₁, in relation to the cases where the first membrane 32 is latched, respectively, to the first bottom plate 52 and to the first top plate 42, and on the hypothesis that the first membrane 32 is in fact mobile according to the design of the MEMS speaker 1.

The first reference voltage REF1 is hence set in such a way that, in the case where the pixel 101 containing the first membrane 32 is intact, it is comprised between Vₜ₂ and Vₜ₄. It hence follows that, in the case where the pixel 101 is intact, the first output voltage V_{OUT1} respects a first condition.

In particular, the first condition envisages that, considering the time interval comprised between the instants t₁ and t₂ and the time interval comprised between the instants t₃ and t₄, the first output voltage V_{OUT1} exceeds the first reference voltage REF1 only in a subinterval of the time interval comprised between the instants t₃ and t₄, and in particular in the interval comprised between an instant t* and the instant t₄. Equivalently, the first condition envisages that Vₜ₂<REF1<Vₜ₄.

In what follows, for brevity, by “inspection time window” is meant the union of the time interval comprised between the instants t₁ and t₂ and of the time interval comprised between the instants t₃ and t₄.

If the pixel 101 is intact, during the inspection time window the voltage of the output terminal of the second differential amplifier 82 is normally positive and has a negative peak only in the subinterval comprised between the instants t* and t₄. It follows that, if by “analysis signal” is meant the signal present on the output terminal of the second differential amplifier 82, it is possible to verify respect of the aforementioned first condition, and hence integrity of the pixel 101, on the basis of the values assumed of the analysis signal.

In particular, in the case where the analysis signal is positive during the time interval comprised between the instants t₁ and t₂, and negative only during the subinterval [t*, t₄], it is possible to infer that the pixel 101 is intact, at least as regards the capacity of the first membrane 32 to latch to the first top plate 42. The second differential amplifier 82 hence functions as detection unit.

The analysis described is hence based on the generation of a signal proportional to the capacitance of the first capacitor C₁, which makes it possible to verify that this first capacitor C₁ assumes the expected values of capacitance for the conditions of latching to the first top plate 42 and the first bottom plate 52. In other words, the operations performed between the instant t_{HZ1} and the instant t₂ enable measurement of the capacitance of the first capacitor C₁, when the first membrane 32 is latched to the first bottom plate 52, or rather, more precisely, when the first membrane 32 should be latched to the first bottom plate 52, in the case of intact pixel. Moreover, the operations performed between the instant t_{HZ2} and the instant t₄ enable measurement of the capacitance of the first capacitor C₁, when the first membrane 32 is latched to the first top plate 42, or rather, more precisely, when the first membrane 32 should be latched to the first top plate 42, in the case of intact pixel. For practical purposes, the plots of the first output voltage V_{OUT1} during the intervals [t₁, t₂] and [t₃, t₄] form corresponding signals of measurement.

In what follows, for brevity, the ensemble of the operations described previously will be referred to as “operations of detection of the capacitance of the first capacitor C₁”.

In addition, or else as an alternative, to the aforementioned operations of detection of the capacitance of the first capacitor C₁, it is possible to carry out operations of detection of the capacitance of the second capacitor C₂.

In detail, the operations of detection of the capacitance of the second capacitor C₂ are similar to the operations of detection of the capacitance of the first capacitor C₁, except for the following differences:
at the instant t_{HZ1}, the control unit 150 controls, instead of the first top-electrode driving circuit 84, the first bottom-electrode driving circuit 86, in such a way that will operate in high-impedance mode;
at the instant t_{SW1}, instead of the first switch 72, the fourth switch 78 is closed;
at the instant t_{SW4}, instead of the first switch 72, the fourth switch 78 is opened;
at the instant t_{HZ2}, the control unit 150 controls, instead of the first top-electrode driving circuit 84, the first bottom-electrode driving circuit 86, in such a way that will operate in high-impedance mode;
at the instant t_{SW5}, instead of the first switch 72, the fourth switch 78 is closed; and
at the instant t_{SW8}, instead of the first switch 72, the fourth switch 78 is opened.

Moreover, in the case of detection of the capacitance of the second capacitor C₂, the evolution of the first output voltage V_{OUT1} in the interval comprised between the instants t₁ and t₂ and in the interval comprised between the instants t₃ and t₄ is reversed with respect to what shown in FIG. 8. We thus find that, in the case where the pixel 101 is intact, the relation Vₜ₂>Vₜ₄ applies.

It follows that, in the case where the pixel 101 is intact, the first output voltage V_{OUT1} respects a second condition. In particular, the second condition envisages that, considering the inspection time window, the first output voltage V_{OUT1} exceeds the first reference voltage REF 1 only in a subinterval (not shown) of the time interval comprised between the instants t₁ and t₂. Consequently, if the pixel 101 is intact, during the inspection time window the voltage of the output terminal of the second differential amplifier 82 is normally positive and has a negative peak only in the aforementioned subinterval of the time interval comprised between the instants t₁ and t₂. It follows that, in the case where the analysis signal is positive during the time interval comprised between the instants t₃ and t₄, and negative only during the aforementioned subinterval of the time interval comprised between the instants t₁ and t₂, it may be inferred that the pixel 101 is intact, at least as regards the capacity of the first membrane 32 to latch to the first bottom plate 52.

In practice, the operations of detection of the capacitance of the second capacitor C₂ are based on the generation of a signal proportional to the capacitance of the second capacitor C₂, which makes it possible to verify that this second capacitor C₂ assumes the expected values of capacitance for the conditions of latching to the first top plate 42 and the first bottom plate 52.

In other words, the operations performed between the instant t_{HZ1} and the instant t₂ enable measurement of the capacitance of the second capacitor C₂, when the first membrane 32 is latched to the first bottom plate 52, or rather, more precisely, when the first membrane 32 should be latched to the first bottom plate 52, in the case of intact pixel. Moreover, the operations performed between the instant t_{HZ2} and the instant t₄ enable measurement of the capacitance of the second capacitor C₂, when the first membrane 32 is latched to the first top plate 42, or rather, more precisely, when the first membrane 32 should be latched to the first top plate 42, in the case of intact pixel. For the practical purposes, the plots of the first output voltage V_{OUT1} during the intervals [t₁, t₂] and [t₃, t₄] once again form corresponding measurement signals.

It should moreover be noted how the first reference voltage REF1 is not modified in the case where it is presumed that, should the pixel 101 be intact, the values of the capacitance of the second capacitor C₂ in conditions of latching of the first membrane 32 to the first bottom plate 52 and to the first top plate 42 are substantially equal, respectively, to the values of the capacitance of the first capacitor C₁ in conditions of latching to the first top plate 42 and to the first bottom plate 52.

Iterating the operations of detection of the capacitance of the first capacitor C₁ and/or the operations of detection of the capacitance of the second capacitor C₂ on all the pixels 10, the entire MEMS speaker 1 is tested.

Moreover, for the reasons described previously, for each pixel 101 it is possible to test the first capacitor C₁ and/or the second capacitor C₂. During these operations, it is found that not more than one pixel switch is closed at a time.

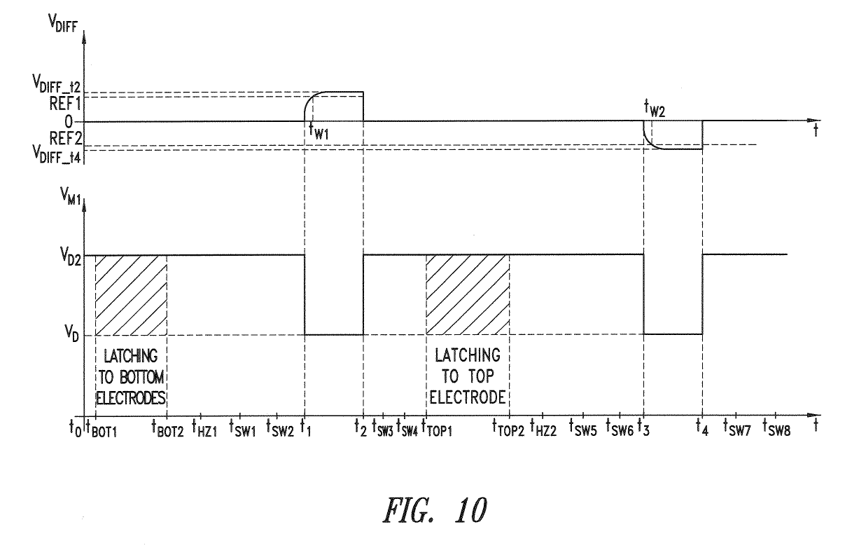

According to a different embodiment, shown in FIG. 9, the fourth switch 78 is arranged between the first bottom electrode B1 and the positive input terminal of the first differential amplifier, which is here designated by 81 and operates in symmetrical configuration. The first differential amplifier 81 hence has two output terminals, which define, respectively, the first output node N_{OUT1} and a second output node N_{OUT2}. Present on the second output node N_{OUT2} is a second output voltage V_{OUT2}; present, instead, between the second output node N_{OUT2} and the first output node N_{OUT1} is a third output voltage V_{DIFF}.

The testing circuit 70 further comprises an additional capacitor C_{F2}, which is the same as the detection capacitor C_{F1}, but is connected between the positive input terminal of the first operational amplifier 81 and the second output node N_{OUT2}. Moreover, the testing circuit 70 comprises a fifth switch 94 and a sixth switch 96. The fifth switch 94 is arranged between the positive input terminal of the first differential amplifier 81 and ground, whilst the sixth switch 96 is arranged between the second output node N_{OUT2} and the third supply voltage V_{DD}/2.

The testing circuit 70 further comprises a detection stage 83, which has four input terminals, two of which are respectively connected to the first and second output nodes N_{OUT1}, N_{OUT2}, the remaining two input terminals are set, respectively, at the first reference voltage REF1 and at a second reference voltage REF2.

In this case, for testing the integrity of the pixel 101, it is possible to carry out the following operations, described with reference to FIG. 10.

Initially, at the instant t₀, the first and fourth switches 72, 78 are open, whereas the second, third, fifth, and sixth switches 74, 76, 94, 96 are closed. Purely by way of example, FIG. 9 refers to the instant tₒ.

Moreover, between the instants t_{BOT1} and t_{BOT2} the operations already described in regard to FIG. 8 are carried out. All the membranes are hence latched, in a way in itself known, to the corresponding bottom plates SRB.

Next, at the instant t_{HZ1}, the control unit 150 controls the first top-electrode driving circuit 84 and the first bottom-electrode driving circuit 86 in such a way that they operate in high-impedance mode.

Then, at the instant t_{SW1}, the first and fourth switches 72, 78 are closed by the control unit 150.

Next, at the instant t_{SW2}, the second, third, fifth, and sixth switches 74, 76, 94, 96 are opened by the control unit 150.

The control unit 150 then applies the first stimulation signal to the input terminal IN_{M1} of the first membrane-electrode driving circuit 88.

In these conditions, at the instant t₁, the third output voltage V_{DIFF} is zero, and then increases until it assumes, at the instant t₂, a value V_{DIFF t2}=(V_{D2}−V_{D})*(C₂−C₁)/C_{F}, where C₁ and C₂ are the capacitances of the first and second capacitors, and C_{F} is the capacitance of the detection capacitor C_{F1} and of the additional capacitor C_{F2}, which, as mentioned previously, are the same as one another.

Next, at the instant t_{SW3}, the second, third, fifth, and sixth switches 74, 76, 94, 96 are closed so as to charge again the detection capacitor C_{F1} to a voltage equal to the third supply voltage V_{DD}/2, maintaining the feedback of the first differential amplifier 80.

Then, at the instant t_{SW4}, the first and fourth switches 72, 78 are opened.

Next, just the first membrane 32 is latched to the first top plate 42, in a way in itself known; the other membranes 2 of the MEMS speaker 1 remain latched, instead, to the corresponding bottom plates SRB. The operations latch the first membrane 32 to the first top plate 42 occur in a time interval comprised between the instant t_{TOP1} and the instant t_{TOP2}.

Next, at the instant t_{HZ2}, the first top-electrode driving circuit 84 and the first bottom-electrode driving circuit 86 are controlled, in a way in itself known, so as to operate in high-impedance mode.

Then, at the instant t_{SW5}, the first and fourth switches 72, 78 are closed.

Next, at the instant t_{SW6}, the second, third, fifth, and sixth switches 74, 76, 94, 96 are opened.

The control unit 150 then applies the second stimulation signal to the input terminal IN_{M1} of the first membrane-electrode driving circuit 88.

In these conditions, at the instant t₃ the third output voltage V_{DIFF} is zero, and then decreases until it assumes, at the instant t₄, a value V_{DIFF}_{_{—}}ₜ₄=(V_{D2}−V_{D})*(C₂−C₁)/C_{F}.

Next, at the instant t_{SW7}, the second, third, fifth, and sixth switches 74, 76, 94, 96 are closed. Finally, at the instant t_{SW8}, the first and fourth switches 72, 78 are opened.

In greater detail, the first and second reference voltages REF1, REF2 are set in a way in itself known, on the basis of the expected deflection of the first membrane 32, and hence on the basis of the corresponding expected values of the capacitances of the first and second capacitors C₁, C₂, when the first membrane 32 is latched to the first bottom plate 52 and to the first top plate 42, and on the hypothesis that the first membrane 32 is mobile according to the design of the MEMS speaker 1.

In particular, it is possible to set the first and second reference voltages REF1, REF2 in such a way that, in the case where the pixel 101 is intact, the relation V_{DIFF}_{_{—}}ₜ₄<REF2<REF1<V_{DIFF}_{_{—}}ₜ₂ applies, where REF1>0 and REF2<0.

In detail, in the case where the pixel 101 is intact, the third output voltage V_{DIFF} respects a third condition. The third condition envisages that, during the aforementioned inspection time window, the third output voltage V_{DIFF} exceeds the first reference voltage REF1 only within the interval comprised between the instants t₁ and t₂, and in particular within of a subinterval comprised between an instant t_{w1} and the instant t₂. In addition, the second condition envisages that the third output voltage V_{DIFF} is lower than the second reference voltage REF2 only within the interval comprised between the instants t₃ and t₄, and in particular within a subinterval comprised between an instant t_{w2} and the instant t₄.

Respect of the third condition, and hence the integrity of the pixel 101, can be verified, for example, by the detection stage 83, which for this purpose operates in a way in itself known. The detection stage 83 hence detects, in a way in itself known, respect of the relations V_{DIFF}_{_{—}}ₜ₄<REF2 and V_{DIFF}_{_{—}}ₜ₂>REF1.

In practice, the operations shown in FIG. 10 envisage generation of a signal proportional to the difference between the capacitances of the first and second capacitors C₁, C₂. In other words, the operations performed between the instant t_{HZ1} and the instant t₂ enable measurement of the difference between the capacitances of the first and second capacitors C₁, C₂, when the first membrane 32 is latched to the first bottom plate 52, and more precisely when the first membrane 32 should be latched to the first bottom plate 52, in the case of intact pixel.

Moreover, the operations performed between the instant t_{HZ2} and the instant t₄ enable measurement of the difference between the capacitances of the first and second capacitors C₁, C₂, when the first membrane 32 is latched to the first top plate 42, and more precisely when the first membrane 32 should be latched to the first top plate 42, in the case of intact pixel. On the basis of these measurements, it is possible to determine the integrity of the pixel 101. Moreover, for practical purposes, the plots of the third output voltage V_{DIFF} during the intervals [t₁, t₂] and [t₃, t₄] form corresponding measurement signals.

The advantages that the present speaker device affords emerge clearly from the foregoing description. In particular, the present speaker device 20 can be tested in accurately and in a way that is substantially immune from possible parasitic capacitance. In addition, the present speaker device 20 comprises a single testing circuit, which may be used for testing any pixel 101. In addition, the stimulation signals are injected into the input terminals IN_{M} of the membrane-electrode driving circuits 8; for this purpose, these membrane-electrode driving circuits 8 are in fact used, without additional hardware. Moreover, the reference voltages present within the testing circuit can be varied in a simple way.

Finally, it is clear that modifications and variations may be made to what has been described and illustrated herein, without thereby departing from the sphere of protection of the present disclosure.

For example, the positive and negative input terminals of each one between the first and second differential amplifiers can be reversed. In this case, the relation between the first output voltage V_{OUT1} and the first reference voltage REF 1 is modified accordingly. It is moreover possible that, instead of the second differential amplifier 82, an analog-to-digital converter and a processing unit are present, which can likewise be present inside the detection stage 83.

As regards the second and third switches 74, 76, these can be replaced by a single switch, which is arranged in parallel to the detection capacitor C_{F1}. Likewise, also the fifth and sixth switches 94, 96 can be replaced by a corresponding switch, which is arranged in parallel to the additional capacitor C_{F2}.

It is also possible that, in order to detect for example the capacitance of the first capacitor C₁ or else of the second capacitor C₂ of any pixel, there is not previously carried out latching of all the membranes to the corresponding bottom plates. In other words, to detect the integrity of each pixel, it is sufficient to latch, at different instants, just the corresponding membrane to the corresponding top plate and to the corresponding bottom plate, in a way altogether independent of what occurs in the other pixels. In addition, for the purposes of the present disclosure, it is irrelevant whether this corresponding membrane is latched first to the bottom plate and then to the top plate, or vice versa. For example, it is thus possible that, after latching all the membranes to the bottom plates, the capacitances of the corresponding first capacitors are measured, and then all the membranes are latched to the corresponding top plates, and finally the capacitances of the corresponding first capacitors are measured again. Alternatively, and once again purely by way of example, it is possible that, after latching all the membranes to the bottom plates, for each membrane the capacitance of the corresponding first capacitor is measured, the membrane is latched to the corresponding top plate, and then the capacitance of the corresponding first capacitor is measured again, before iterating the operations on the next membrane.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A MEMS speaker device, comprising:
an elementary unit, said elementary unit including:
a membrane;
a top plate; and
a bottom plate, the membrane being between the top plate and the bottom plate and forming a first capacitor and a second capacitor, with the top plate and with the bottom plate, respectively,
an electronic driving circuit configured to, during a first operating period, move the membrane into a first position, in which the membrane is closer to the bottom plate, and during a second operating period, to move the membrane into a second position, in which the membrane is closer to the top plate;
an electronic test circuit including:
a first measuring circuit configured to generate a first measurement signal based on a capacitance of a first one of the first and second capacitors, after the first operating period, said first measuring circuit being configured to generate a second measurement signal based on the capacitance of said first one of the first and second capacitors, after the second operating period; and
a first comparator circuit configured to compare said first and second measurement signals with at least one first electrical reference quantity, and to detect a mobility of the membrane in a direction of the top plate or the bottom plate, based on the comparison.

2. The device according to claim 1 wherein said first and second measurement signals are proportional to the capacitance of said first one of the first capacitor and the second capacitor, and wherein the first comparator circuit is configured to detect that:
if the capacitance is from the first capacitor, the first measurement signal does not exceed the first electrical reference quantity, and the second measurement signal exceeds said first electrical reference quantity; and
if the capacitance is from the second capacitor, the first measurement signal exceeds the first electrical reference quantity, and the second measurement signal does not exceed said first electrical reference quantity.

3. The device according to claim 2 wherein the electronic test circuit includes:
a second measuring circuit configured to generate a third measurement signal proportional to the capacitance of a second one of said first and second capacitors, after the first operating period, said second measuring circuit being configured to generate a fourth measurement signal proportional to the capacitance of the second one of said first and second capacitors, after the second operating period; and
a second comparator circuit designed to compare said third and fourth measurement signals with a second electrical reference quantity, for detecting the mobility of the membrane in the direction of the top plate or the bottom plate.

4. The device according to claim 1 wherein the first measurement signal is proportional to a difference between capacitances of said first and second capacitors, after the first operating period, and the second measurement signal is proportional to the difference between the capacitances of said first and second capacitors, after the second operating period.

5. The device according to claim 4 wherein the first comparator circuit is configured to detect that:
a first one of the first and second measurement signals exceeds the first electrical reference quantity; and
a second one of said first and second measurement signals is lower than a second electrical reference quantity, which is lower than the first electrical reference quantity.

6. The device according to claim 1 wherein said electronic driving circuit includes a top-electrode driving circuit, a membrane driving circuit and a bottom-electrode driving circuit, coupled to the top plate, to the membrane, and to the bottom plate, respectively, said top-electrode driving circuit, said membrane driving circuit, and said bottom-electrode driving circuit being configured to generate a top-electrode driving signal, a membrane driving signal, and a bottom-electrode driving signal, respectively, the top-electrode driving signal, the membrane driving signal, and the bottom-electrode driving signal being configured to cause movement of the membrane alternatively towards the top plate and towards the bottom plate when the elementary unit is operational.

7. The device according to claim 6 wherein during said first operating period:
at a first instant in time, the top-electrode driving signal and the bottom-electrode driving signal are equal to a first voltage, and the membrane driving signal is equal to a second voltage;
at a second instant in time, the top-electrode driving signal and the membrane driving signal are equal to a third voltage, and the bottom-electrode driving signal is equal to the first voltage; and
at a third instant in time, the top-electrode driving signal and the bottom-electrode driving signal are equal to the first voltage, and the membrane driving signal is equal to the second voltage;
and wherein, during said second operating period:
at a first instant in time, the top-electrode driving signal and the bottom-electrode driving signal are equal to the first voltage, and the membrane driving signal is equal to the second voltage;
at a second instant in time, the bottom-electrode driving signal and the membrane driving signal are equal to the third voltage, and the top-electrode driving signal is equal to the first voltage; and
at a third instant in time, the top-electrode driving signal and the bottom-electrode driving signal are equal to the first voltage, and the membrane driving signal is equal to the second voltage.

8. The device according to claim 6, further comprising a coupling circuit configured to uncouple electrically the first measuring circuit from the top plate or the bottom plate, during said first and second operating periods, and to couple the first measuring circuit to the top plate or the bottom plate, in periods other than said first and second operating periods; and wherein the membrane driving circuit is configured to generate a first pulse and a second pulse, respectively after the first and second operating periods.

9. The device according to claim 8 wherein said first measuring circuit includes at least one amplifier with capacitive feedback, which is configured to amplify said first and second pulses.

10. The device according to claim 1 wherein the first measuring circuit is configured to generate the first measurement signal based on a difference between capacitances of the first and second capacitors after the first operating period, and the first measuring circuit is configured to generate the second measurement signal based on a difference between the capacitances of the first and second capacitors after the second operating period.

11. A method, comprising:
testing a MEMS speaker device, the testing including:
operating at least one elementary unit in a first operating period and a second operating period with a driving device, said elementary unit including a membrane, a top plate, and a bottom plate, the membrane being arranged between the top plate and the bottom plate and forming a first capacitor and a second capacitor, respectively with the top plate and with the bottom plate, the operating including:
moving the membrane into a first position, in which the membrane is close to the bottom plate in the first operating period; and
moving the membrane into a second position, in which the membrane is close to the top plate during a second operating period;
after the first operating period, generating a first measurement signal based on a capacitance of a first one of said first and second capacitors;
after the second operating period, generating a second measurement signal based on the capacitance of said first one of said first and second capacitors; and
detecting a mobility of the membrane in a direction of the top plate or the bottom plate that forms said first one of said first and second capacitors, said detecting the mobility including:
comparing said first and second measurement signals with a first electrical reference quantity.

12. The method according to claim 11 wherein the generating the first and second measurement signals includes generating said first and second measurement signals that are proportional to the capacitance of said first one of the first and second capacitors; and
detecting that:
if the capacitance is from the first capacitor, the first measurement signal does not exceed the first electrical reference quantity, and the second measurement signal exceeds said first electrical reference quantity; and
if the capacitance is from the second capacitor, the first measurement signal exceeds the first electrical reference quantity, and the second measurement signal does not exceed said first electrical reference quantity.

13. The method according to claim 12, further comprising:
generating, after the first operating period, a third measurement signal proportional to a capacitance of a second one of said first and second capacitors;
generating, after the second operating period, a fourth measurement signal proportional to the capacitance of said second one of said first and second capacitors; and
detecting the mobility of the membrane in the direction of the top plate or the bottom plate that forms said second one of said first and second capacitors, said detecting including comparing said third and fourth measurement signals with a second electrical reference quantity.

14. The method according to claim 11 wherein the operating is performed using an electronic driving circuit that includes a top-electrode driving circuit, a membrane driving circuit, and a bottom-electrode driving circuit, which are coupled to the top plate, to the membrane, and to the bottom plate, respectively, said method further comprising:
electrically uncoupling, during said first and second operating periods, the first measuring circuit from the top plate or the bottom plate that forms the capacitance;
coupling, in periods other than said first and second operating periods, the first measuring circuit to the top plate or the bottom plate that forms the capacitance; and
generating, using the membrane driving circuit, a first pulse and a second pulse, respectively after the first and second operating periods.

15. The method according to claim 14 wherein the generating the first and second measurement signals includes amplifying said first and second pulses.

16. The method according to claim 11 wherein the generating the first measurement signal includes generating the first measurement signal to be proportional to a difference between capacitances of said first and second capacitors, and wherein the generating the second measurement signal includes generating the second measurement signal to be proportional to the difference between the capacitances of said first and second capacitors.

17. The method according to claim 16, further comprising detecting whether:
a first one of the first and second measurement signals exceeds the first electrical reference quantity; and
a second one of said first and second measurement signals is lower than a second electrical reference quantity, which is lower than the first electrical reference quantity.

18. The method according to claim 16 wherein the operating is performed using an electronic driving circuit that includes a top-electrode driving circuit, a membrane driving circuit, and a bottom-electrode driving circuit, which are, coupled to the top plate, to the membrane, and to the bottom plate, respectively, said method further comprising:
during said first and second operating periods, electrically uncoupling the first measuring circuit from the top plate and from the bottom plate;
in periods other than said first and second operating periods, coupling the first measuring circuit to the top plate and to the bottom plate; and
generating, using the membrane driving circuit, a first pulse and a second pulse, respectively after the first and second operating periods.

19. A device, comprising:
an array of elements, each element including:
a membrane;
a top plate;
a bottom plate, the membrane being between the top plate and the bottom plate and configured to form a first capacitor and a second capacitor, with the top plate and with the bottom plate, respectively;
a testing circuit coupled to the array of elements, the testing circuit including:
a first switch coupled between the top plates and a first node;
a second switch coupled between the bottom plates and the first node;
a comparator having a first input coupled to the first node, a second input coupled to ground, and an output;
a detection unit having a first input coupled to the output of the comparator, a second input coupled to a first voltage, and an output;
a third switch coupled between ground and the first node;
a fourth switch coupled between the output of the comparator and a second voltage;
a third capacitor coupled between the first node and the output of the comparator.

20. The device of claim 19, further comprising:
a control unit configured to control the first, second, third, and fourth switch to test the array of elements.
